(19) United States
(12) Patent Application Publication
(10) Pub. No.: US 2012/0186725 A1
(43) Pub. Date: Jul. 26, 2012

(54) TIRE TREAD STRIP AND METHOD OF PREPARATION

(76) Inventors: Ramendra Nath Majumdar, Hudson, OH (US); Dale Roy Norton, Medina, OH (US)

(21) Appl. No.: 13/437,421

(22) Filed: Apr. 2, 2012

Related U.S. Application Data
(62) Division of application No. 12/337,699, filed on Dec. 18, 2008.

(51) Int. Cl. B29D 30/52

(52) U.S. Cl. 156/96

(57) ABSTRACT

This invention relates to a tire tread strip and method of preparation.

### FIELD OF INVENTION

This invention relates to a tire tread strip and method of preparation.

### BACKGROUND OF THE INVENTION

Retreaded tires are typically prepared, for example, by applying a pre-cured rubber tread (e.g. rubber tread strip which has been cured) to a circumferential uncured rubber layer, sometimes referred to as a “cushion layer”, which overlays a buffed tire rubber carcass from which the original rubber tread has been removed by abrading it away, to form an assembly thereof and the assembly cured at an elevated temperature to form a cured retreaded rubber tire. Such tire retreading process is well known to those having skill in such art.

In one embodiment, an uncured cushion rubber layer is applied to the buffed tire carcass where the cushion layer which has a surface with suitable building tack for which a need of applying a tack enhancing cement to the pre-cured rubber tread can be eliminated. Cushion rubber layers with building tack are described in U.S. Pat. Nos. 5,503,940 and 6,186,202 and U.S. Patent application No. 2005/0211351.

For this invention, a cured rubber tread strip is provided with a plurality of lockable cavities (open cavities) in its bottom surface and which has a protective, polymeric film releasibly (removably) adhered to its bottom surface including the walls of its lockable cavities.

For this invention, a retreaded tire is provided with a rubber tread having a plurality of lockable cavities wherein said tread is mechano-chemically bonded to a rubber tire carcass by its lockable cavities.

Such cured rubber tread strip (which might sometimes be referred to as being a pre-cured rubber tread strip) which contains a plurality of lockable cavities molded into a bottom surface thereof is prepared by:

(A) applying a releasable film (a flat film which optionally has a textured surface) to a surface of an uncured rubber tread strip to form a composite thereof;

(B) applying a mold release agent to the surfaces of said uncured tread rubber strip composite including at least a portion of the surface of said protective polymeric film on said rubber strip;

(C) applying the release agent coated uncured tread rubber strip composite to a metal plate where said metal plate has:
(1) a plurality of protrusions thereon to form an assembly thereof, or
(2) a roughened surface to form an assembly thereof;

(D) positioning said assembly in a suitable mold and applying an elevated temperature and pressure to:
(1) cause said protrusions of said metal plate to extend into and form lockable cavities in the surface of rubber tread strip, or
(2) cause said roughened surface to impart a roughened surface on the surface of said rubber tread strip;
   and to cure said lockable cavity-containing, or roughened surface-containing, rubber tread strip at a temperature in a range of from about 145° C. to about 180° C. to form a rubber tread strip composite comprised of a cured rubber tread strip with a plurality of lockable cavities in its bottom surface, or roughened surface on its bottom surface, and said removable protective polymeric film molded thereon on said cured rubber tread strip including the walls of its lockable cavities or roughened surface.

In such manner, the uncured rubber tread strip may be molded and pre-cured in a suitable mold together with the removable polymeric film which becomes molded onto (removably adhered to) a surface of the tread rubber (tread rubber strip) during its molding and curing operation.

The removable film may then be removed from the pre-cured tread rubber strip to provide a “clean” rubber surface for the pre-cured rubber tread.

In this manner, the “clean” rubber surface is provided without the necessity of buffing the rubber surface of the tread strip. This is seen herein as being a particular advantage in a sense that mechanically administered buffing, of abrading, submits the cured rubber surface to additional heat history and promotes surface oxidation of the buffed rubber surface.

This overall procedure is entirely different from a past practice of buffing the tread strip surface, applying cement to the buffed surface and post-applying a protective plastic film (usually polyethylene film) to prevent contamination of the cemented surface. By the practice of this invention, surface contamination and atmospheric oxidation of the cured tread can be prevented, or retarded, during storage of the pre-cured rubber tread without a requirement of post application of a cement and protective plastic film.

In practice the lockable cavities for the tire tread strip are not limited to a particular shape and configuration.

For example, the individual lockable cavities in the tread strip may have a circular, oval, rectangular, longitudinal, serpentine, trapezium, or sinusoidal cross-sectional shape.

For example, the individual lockable cavities in the tread strip may be individually dispersed, transversally oriented or longitudinally oriented insofar as the surface of the tread strip is concerned.

Historically, a significant problem envisioned in simply applying a protective polymeric film for such purpose to the surface of the uncured rubber tread strip is that a typical thermoplastic film, such as for example a polyethylene film, is viewed herein as being unsatisfactory in a sense that such thermoplastic film does not have sufficient dimensional stability and resistance to tear for removal from the surface of the tread rubber strip after it is removed from the mold and, further, that it typically has a melting point (ASTM D98) significantly below 150° C. and would therefore normally melt at typical rubber cure temperatures such as for example about 150° C. (for example, in a range of from about 145° C. to about 180° C.).

Therefore, a suitable film for such purpose is viewed herein as being significantly dimensionally stable so that it can be removed from the surface of the pre-cured rubber tread surface after the uncured tread strip to which it has been applied has been molded and cured in a suitable mold at an elevated temperature (e.g. at least about 145° C. and in a range of, for example, from about 145° C. to about 180° C.).

In practice, it has been found that a film comprised of, for example, nylon 6,6 or nylon 6 may be used in the sense of applying it to a surface of said uncured tread rubber strip to form a removable film bonded (physically adhered) to the bottom surface of the cured tread rubber strip.

### SUMMARY AND PRACTICE OF THE INVENTION

In accordance with this invention a cured rubber tire tread strip is provided having a bottom surface with at least one of:

(A) a plurality of lockable cavities, or

(B) an embossed pattern to provide a roughened surface, and which has a protective, polymeric film releasably adhered to (e.g. releasably bonded to) its bottom surface.

Such lockable cavities in said cured tread rubber strip are lockable in a sense of being capable of interlocking (e.g. mechano-chemically interlocking) with a rubber cushion layer positioned on a tire cured rubber carcass wherein portions of said rubber cushion layer are caused to protrude into said lockable cavities following which the rubber cushion layer is cured to physically and chemically lock (e.g. secure) said tread rubber strip to said rubber cushion layer and thereby form a tire assembly comprised of a tire carcass and tread strip with said cushion layer therebetween.

Significant aspects of this invention are at least threefold, namely providing of said lockable cavities in said rubber tread strip, or providing said roughened surfaced rubber tread strip, providing said adherent, bonded, releasable polymeric film to protect the surface of said rubber strip, and removal of said polymeric film from the cured rubber tread strip to thereby provide a clean rubber surface of the cured tread rubber strip and particularly the walls of said lockable cavities to make the surface and lockable cavities of the tread rubber strip available for interlocking with a cushion rubber layer for a tire.

In further accordance with this invention, a retreaded tire is provided which is comprised of a circumferential cured rubber tread layer having a surface which:

(A) contains cavities which are mechano-chemically interlocked with a cushion rubber layer of a tire rubber carcass, and/or

(B) contains an unbuffed embossed pattern which provides a roughened surface which is adhered to a cushion rubber layer of a tire rubber carcass.

In further accordance with this invention, a pre-cured tread for a retreaded tire is prepared by a process which comprises;

(A) applying a protective removable polymeric film to an uncured rubber tread strip to form a composite thereof, wherein said polymeric film has a melt point, ASTM D789, significantly higher than the cure temperature for said tread rubber strip (desirably a melt point of at least about 190° C.);

(B) applying a mold release agent (e.g. a polysiloxane based release agent) to the surfaces of said uncured tread rubber strip composite including at least a portion of the surface of said protective polymeric film on said rubber strip;

(C) applying the release agent coated uncured tread rubber strip composite to a metal plate where said metal plate has:
(1) a plurality of protrusions thereon to form an assembly thereof, or
(2) a roughened surface to form an assembly thereof;

(D) positioning said assembly in a suitable mold and applying an elevated temperature and pressure to:
(1) cause said protrusions of said metal plate to extend into and form lockable cavities in the surface of rubber tread strip, or
(2) cause said roughened surface to impart a roughened surface on the surface of said rubber tread strip;
   and to cure said lockable cavity-containing, or roughened surface-containing, rubber tread strip at an elevated temperature (e.g. temperature in a range of from about 145° C. to about 180° C.) to form a rubber tread strip composite comprised of a cured rubber tread strip with a plurality of lockable cavities in its bottom surface, or roughened surface on its bottom surface, and said removable protective polymeric film molded thereon on said cured rubber tread strip including the walls of its lockable cavities or roughened surface.

Alternatively, a cured rubber tread strip is prepared by a process which comprises;

(A) applying a protective removable polymeric film to an uncured rubber tread strip to form a composite thereof, wherein said polymeric film has a melt point, ASTM D789, significantly higher than the cure temperature for said tread rubber strip (desirably a melt point of at least about 190° C.), wherein said protective polymeric film has:
(1) a plurality of protrusions thereon, or
(2) an embossed pattern to thereby provide a roughened surface thereon;

(B) applying a mold release agent (e.g. a polysiloxane based release agent) to the surfaces of said uncured tread rubber strip composite including at least a portion of the surface of said protective polymeric film on said rubber strip;

(C) applying the release agent coated uncured tread rubber strip composite to a flat surfaced metal plate;

(D) positioning said assembly in a suitable mold and applying an elevated temperature and pressure to:
(1) cause said protrusions of said protective polymeric film to extend into and form lockable cavities in the surface of the rubber tread strip, or
(2) cause said roughened surface of said protective polymeric to impart a correspondingly roughened surface to the surface of the rubber tread strip;

and curing said rubber tread strip at an elevated temperature (e.g. temperature in a range of from about 145° C. to about 180° C.) to form a cured rubber tread strip having said removable protective polymeric film molded thereon on said cured rubber tread strip including the walls of its lockable cavities or roughened surface.

In practice, said polymeric film is not melted onto the tread rubber surface during said molding and curing of the tread rubber strip (because said polymeric film has a melt point significantly higher than the cure temperature for the tread rubber strip) and is thereby removable from the cured rubber tread.

In further practice of this invention, said protective polymeric film is removed from the surface of said cured rubber tread strip to yield a cured rubber tread strip having a clean unbuffed rubber surface free from mold release agent coating.

In additional practice of this invention, a cured rubber tread strip is provided having a clean, unbuffed surface free of mold release agent coating, particularly being prepared by said method.

As hereinbefore mentioned, said protective polymeric film is applied to the surface of said uncured rubber tread strip.

In additional accordance with this invention, a process of preparing a retreaded tire is comprised of:

(A) applying a clean, (uncemented), unbuffed surface of a pre-cured rubber tire tread layer to a circumferential uncured adhesive rubber layer, without an adhesive coating therebetween, wherein said circumferential uncured adhesive rubber layer overlays a cured rubber tire carcass to form an assembly thereof, and

(B) curing said assembly an elevated temperature and pressure to form a cured retreaded rubber tire;

wherein said pre-cured rubber tire tread layer is prepared by:
(1) applying a polymeric film to one surface of an uncured rubber tread strip to form a composite thereof;
(2) applying a release agent coating to the surfaces of said composite, including at least a portion of said polymeric film;
(3) applying the release agent coated uncured tread rubber strip composite to a metal plate where said metal plate has:
   (a) a pluralilty of protrusions thereon to form an assembly thereof, or
   (b) a roughened surface to form an assembly thereof;
(4) positioning said assembly in a suitable mold and applying an elevated temperature and pressure to:
   (a) cause said protrusions of said metal plate to extend into and form lockable cavities in the surface of rubber tread strip, or
   (b) cause said roughened surface to impart a roughened surface on the surface of said rubber tread strip;
      and curing said lockable cavity-containing, or roughened surface-containing, rubber tread strip at an elevated temperature (e.g. temperature in a range of from about 145° C. to about 180° C.) to form a rubber tread strip composite comprised of a cured rubber tread strip with a plurality of lockable cavities in its bottom surface, or roughened surface on its bottom surface, and said removable protective polymeric film molded thereon on said cured rubber tread strip including the walls of its lockable cavities or roughened surface;
(5) removing said polymeric film from said pre-cured rubber tread to provide a clean, unbuffed surface on said pre-cured rubber tread prior to applying said pre-cured tread to the circumferential uncured cushion rubber layer.

Alternatively, said pre-cured rubber tread layer for said retreaded tire is prepared by:

(A) applying a protective removable polymeric film to an uncured rubber tread strip to form a composite thereof, wherein said polymeric film has a melt point, ASTM D789, significantly higher than the cure temperature for said tread rubber strip (desirably a melt point of at least about 190° C.), wherein said protective polymeric film has:
(1) a plurality of protrusions thereon, or
(2) an embossed pattern to thereby provide a roughened surface thereon;

(B) applying a mold release agent (e.g. a polysiloxane based release agent) to the surfaces of said uncured tread rubber strip composite including at least a portion of the surface of said protective polymeric film on said rubber strip;

(C) applying the release agent coated uncured tread rubber strip composite to a flat surfaced metal plate;

(D) positioning said assembly in a suitable mold and applying an elevated temperature and pressure to:
(1) cause said protrusions of said protective polymeric film to extend into and form lockable cavities in the surface of the rubber tread strip, or
(2) cause said roughened surface of said protective polymeric to impart a correspondingly roughened surface to the surface of the rubber tread strip;

and curing said rubber tread strip at an elevated temperature (e.g. temperature in a range of from about 145° C. to about 180° C.) to form a cured rubber tread strip having said removable protective polymeric film molded thereon on said cured rubber tread strip including the walls of its lockable cavities or roughened surface.

In practice, said polymeric film may be, for example, a nylon film.

Representative of nylon based polymeric films are, for example:

(A) films of ring opening polymerized lactams having from 6 to 12 carbon atoms (e.g. caprolactam) such as, for example, nylon 6 as a poly(imino(1-oxohexamethylene)) (polyamide-6) typically having a melting point in a range in a range of from about 200° C. to about 220° C. (ASTM D789), from the Honeywell Company, and

(B) films of a polycondensate of a diamine and dicarboxylic acid such as, for example, nylon 6,6 as a poly(iminohexamethyleneiminoadipoyl) (polyamide-66) typically having a melting point in a range of from about 250° C. to about 260° C. (ASTM D789), a product of the DuPont Company.

In one embodiment, said circumferential cushion rubber layer composition is comprised of, for example, a layer of an elastomeric rubber composition comprised of at least one conjugated diene-based elastomer, for example, cis 1,4-polyisoprene rubber (usually natural rubber) and, optionally cis 1,4-polybutadiene rubber, which contains a bis-imide compound and tackifier resin (see U.S. Pat. No. 5,503,940). For example, said bis-imide compound may be comprised of an N,N′m-xylene biscitraconic imide as Perkalink 900™, N,N′-m-phenylene bismaleimide, 1,1′(methylenedi-4,1-phenylene) bis maleimide, or combinations thereof (preferably comprised of said N,N′m-xylene biscitraconic imide), the tackifier as a phenol-formaldehyde tackifier resin.

A significant aspect of the invention is considered herein as both providing a process of providing an improved pre-cured rubber tread with its plurality of lockable cavities, in the production of a cured rubber tread strip retreading a rubber tire with a cured rubber tread strip having a clean, unbuffed surface without a cement coating.

A further significant aspect of the invention is considered herein as both providing an improved tire retreading process and a resultant retread tire.

This is considered herein as being significant in a sense of providing a more secure mechano-chemical bonding of the lockable cavity-containing rubber tread to the tire carcass with the intermediate cushion layer.

### BRIEF DESCRIPTION OF THE DRAWINGS

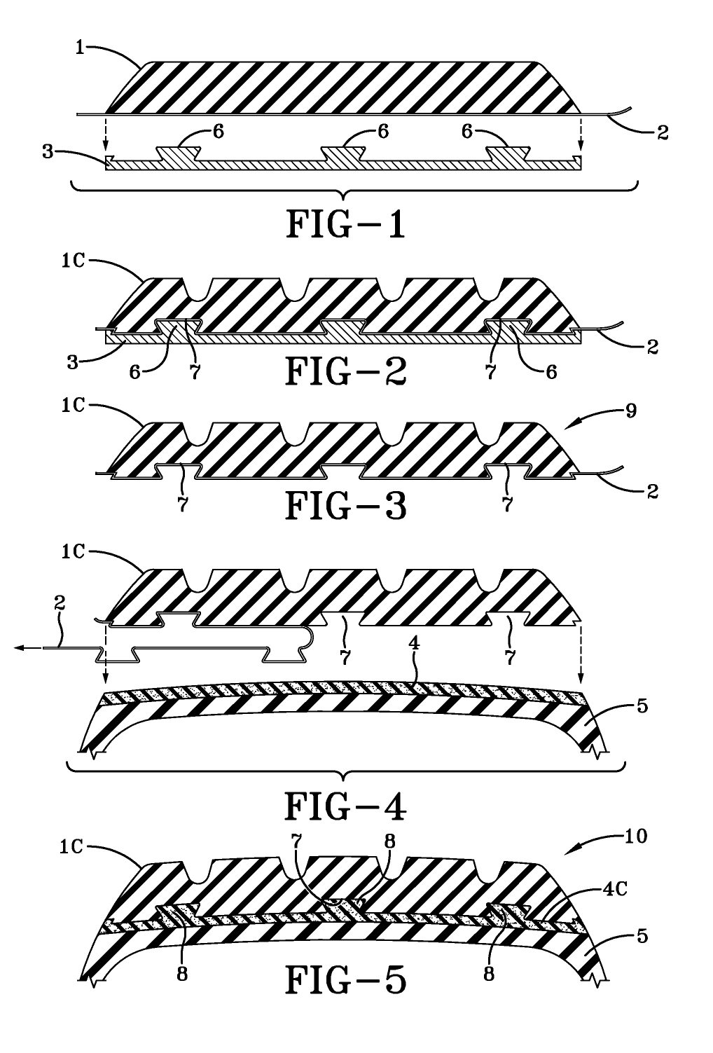

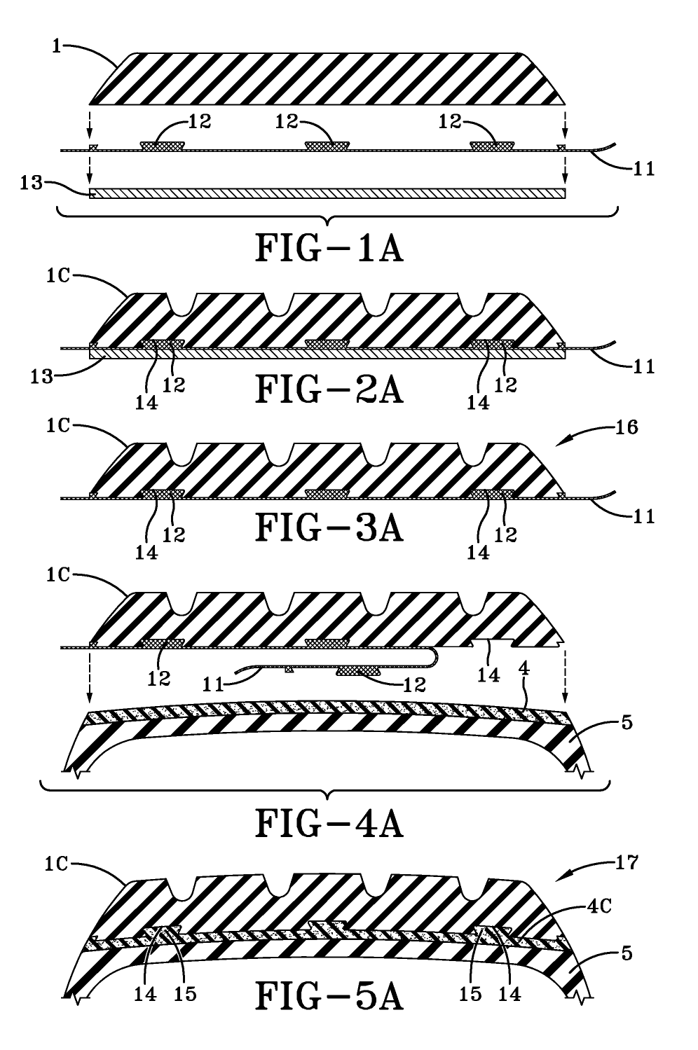

Drawings are provided for a further understanding of the invention. In the Drawings, FIGS. 1 through 5 and FIGS. 1A through 5A are provided to depict cross sections of a tread and cushion layer-containing tire to illustrate a tire tread with a plurality of lockable cavities and associated retreaded tire.

In the Drawings FIG. 1 through FIG. 5
In FIG. 1, an uncured tread rubber strip (1) is depicted with a protective heat deformable polymeric film (2) applied to its bottom surface to form a composite of the rubber strip (1) and polymeric film (2). A rigid metal plate (3) is also shown with a plurality of protrusions (6) of a trapezium cross-section extending from its upper surface and facing the aforesaid film (2) layer of the composite. The polymeric film (2) is comprised of a protective polymeric film of nylon 6 (melt point in a range of from about 200° C. to about 220° C., ASTM D789) or nylon 6,6 (melt point in a range of from about 250° C. to about 260° C., ASTM D789). A release agent coating of a polysiloxane is applied to the surfaces of tread strip (1) and protective film (2).

In FIG. 2, the composite of uncured tread rubber strip (1) with its applied protective polymeric film (2) and metal plate (3) are pressed together in a suitable mold to cause the protrusions (6) of the trapezium design (short parallel side affixed to the metal plate) to press into and form a plurality of lockable cavities (7) of a trapezium configuration in the composite. The tread rubber strip (1) is then cured within the mold at an elevated temperature of about 180° C. to form a cured tread strip (1C) containing the protective polymeric film strip (2) and lockable cavities (7) in its bottom surface.

In FIG. 3, the metal plate (3) is removed to leave the composite (9) composed of the cured tread (1C) with its protective, removable polymeric film strip (2) on its bottom surface and the plurality of lockable cavities (7) of trapezium configurations in its bottom surface.

In FIG. 4, the protective polymeric film strip (2) is peeled away from the bottom surface of the cured rubber tread strip (1C) leaving the lockable cavities (7) exposed in its bottom surface. Further, a tire casing (5) is provided with its tread having been buffed off and an uncured cushion rubber layer (4) applied to its buffed surface.

In FIG. 5, the cured rubber tread (1C) is pressed onto the uncured rubber cushion (4) and the resulting assembly placed in an envelope and the enveloped assembly placed in a heated chamber (autoclave). The elevated temperature of the chamber and pressure exerted by the envelope causes portions (8) of the uncured rubber cushion (4) to extend into the lockable cavities (7) of the cured tread (1C), to form a retreaded tire (10) by curing the rubber cushion layer (4) to form a cured rubber cushion layer (4C) and to thereby both bond the rubber cushion layer (4) to the tire carcass (5) and to create a mechano-chemical interlocking of the trapezium configured lockable cavities of the cured tire tread (1C) and cured rubber cushion layer (4C).

In the Drawings FIG. 1A through FIG. 5A

In FIG. 1A, an uncured tread rubber strip (1) is depicted. A protective heat deformable polymeric film (11) having a plurality of protrusions (12) thereon its depicted rigid flat surfaced metal plate (13) is also shown. The polymeric film (11) is comprised of a protective polymeric film of nylon 6 (melt point in a range of from about 200° C. to about 220° C., ASTM D789) or nylon 6,6 (melt point in a range of from about 250° C. to about 260° C., ASTM D789). A release agent coating of a polysiloxane is applied to the surfaces of tread strip (1) and protective film (11).

In FIG. 2A, the uncured tread rubber strip (1) the protective polymeric strip (11) is provided and fitted to the metal strip (13) to form a composite thereof. The composite is placed in a suitable mold to cause the protrusions (12) to press into and form a plurality of lockable cavities (14) in the rubber tread strip while curing the rubber strip within the mold at an elevated temperature of about 180° C. to form a cured tread strip (1C) containing the protective polymeric film strip (11) and associated lockable cavities (14) in its bottom surface.

In FIG. 3A, the metal plate (13) is removed to leave a composite (16) composed of the cured tread (1C) with its protective, removable polymeric film strip (11) on its bottom surface and the plurality of lockable cavities (14) in its bottom surface.

In FIG. 4A, the protective polymeric film strip (11) is peeled away from the bottom surface of the cured rubber tread strip (1C) leaving the lockable cavities (14) exposed in its bottom surface. Further, a tire casing (5) is provided with its tread having been buffed off and an uncured cushion rubber layer (4) applied to its buffed surface.

In FIG. 5A, the cured rubber tread (1C) is pressed onto the uncured rubber cushion (4) and the resulting assembly placed in an envelope and the enveloped assembly placed in a heated chamber (autoclave). The elevated temperature of the chamber and pressure exerted by the envelope causes portions (15) of the uncured rubber cushion (4) to extend into the lockable cavities (14) of the cured tread (1C), to form a retreaded tire (17) by curing the rubber cushion layer (4) to thereby both bond the now cured rubber cushion layer (4C) to the tire carcass (5) and to create a mechano-chemical interlocking of lockable cavities (14) of the cured tire tread (1C) and cured rubber cushion layer (4C).

For the cushion rubber layer (4), a rubber composition is provided which is comprised of an elastomeric rubber composition comprised of at least one conjugated diene-based elastomer, for example, cis 1,4-polyisoprene natural rubber and, optionally cis 1,4-polybutadiene rubber, which contains a bis-imide compound and tackifier resin (see U.S. Pat. No. 5,503,940). Said bis-imide compound is comprised of N,N′m-xylene biscitraconic imide, together with a tackifier as a phenol-formaldehyde tackifier resin.

The following example is provided to further illustrate the invention. The parts and percentages, if referenced, are by weight unless otherwise indicated.

### EXAMPLE I

Pre-cured tread rubber samples (Test Samples) were prepared to evaluate their adhesion to a tread cushion rubber composition.

For the adhesion evaluation, uncured rubber samples in a shape of about 6 inches by 6 inches with a thickness of about 0.095 inch (about 15.2×15.2×0.24 cm) was die-cut from a milled 0.24 cm thick natural rubber based rubber strip. The rubber sample was in one sense, although smaller, similar to the uncured tread strip (1) depicted in FIG. 1. One side of the rubber sample was reinforced with a 0.033 inch (0.08 cm) thick treated fabric to add dimensional stability to the rubber sample.

### A. Preparation of Smooth Surfaced Pre-Cured Rubber Test Sample (Test Piece 1)

An undrawn nylon-6 film was applied to the non-fabric side of an uncured rubber Test Sample. The nylon-6 film side of the Test Sample was pressed against a smooth surface of a metal plate and the Test Sample cured (about 8 minutes at about 182° C. and pressure of about 0.7 MPa) to form a smooth surfaced pre-cured Test Sample.

### B. Preparation of Rough Surfaced Pre-Cured Rubber Test Sample (Test Piece 2)

An undrawn nylon-6 film was applied to the non-fabric side of an uncured rubber Test Sample. The nylon-6 film side of the Test Sample was pressed against a rough, textured surface of a metal plate and the Test Sample cured (about 8 minutes at about 182° C. and pressure of about 0.7 MPa) to form a smooth surfaced pre-cured Test Sample.

### C. Preparation of Cavity Containing Pre-Cured Rubber Test Sample (Test Piece 3)

An undrawn nylon-6 film was applied to the non-fabric side of an uncured rubber Test Sample. The nylon-6 film side of the Test Sample was pressed against a metal plate with a surface containing a metal strip as a protrusion of a trapezium configuration affixed to and extending outward from the plate to form a plurality of lockable cavities in the Test Sample surface—and the Test Sample cured (about 8 minutes at about 182° C. and pressure of about 0.7 MPa) to form a pre-cured Test Sample containing a plurality of lockable cavities in its surface. The protrusions in the metal plate were prepared by affixing two 6 inch (15.2 cm) long metal strips to a smooth metal plate. The protrusions had a trapezium shaped cross section similar to the protrusions depicted in FIG. 1 of the Drawings. The depth of the trapezium shaped protrusion was 0.075 inch (0.2 cm) and the two sides were 0.372 inch (0.1 cm) and 0.5 inch (1.3 cm) where the 0.375 inch (0.1 cm) side was affixed to the smooth surface of the metal plate. The plate was aligned in such a way that the metal strips were perpendicular to the cords of the fabric on the other side of the Test Sample.

### D. Preparation of Uncured Tacky Cushion Rubber Sample (Test Piece 4)

An uncured rubber sample in a shape of about 6 inches by 6 inches with a thickness of about 0.095 inch (about 15.2×15.2×0.24 cm) was die-cut from a milled 0.24 cm thick rubber strip. The rubber sample was in one sense similar to the uncured cushion rubber strip (4) depicted in FIG. 4 and comprised of a 40 phr natural rubber and 60 phr cis 1,4-polybutadiene rubber based rubber composition containing an N,N′m-xylene biscitraconic imide, together with a tackifier resin (e.g. phenol-formaldehyde tackifier resin). One side of the rubber sample was reinforced with a fabric to add dimensional stability to the rubber sample.

### E. Adhesion Testing of the Test Rubber Samples to Said Cushion Rubber

After removal of the nylon-6 protective removable film, the resulting clean surfaces of the Test Sample Pieces 1, 2 and 3, respectively, were individually pressed against a Cushion Rubber Sample Piece 4 with the fabric cords being aligned in the same direction and then cured at about 8 minutes at about 182° C. and pressure of about 0.7 MPa. Strips of 2.54 cm width were died-out along the cord direction of the fabric and each Test piece was about 2.54 cm wide by about 15.24 cm long. The Test pieces were pulled using an Instron instrument and adhesions, force to pull them apart, (steady state average peak load in N/cm) were measured at room temperature (about 23° C.) and at 95° C. at a cross head speed of 50.8 cm/min. The results are shown in Table 1.

TABLE 1
Adhesion for Smooth, Rough and Lockable
Cavity Surfaced Test Samples

| Property | Smooth | Rough | Cavity |
|---|---|---|---|
| Adhesion at Room Temperature (N/cm) | 109 | 191 | 281 |
| Adhesion at 95° C. (N/cm) | 37 | 56 | 110 |

It can be seen from Table 1 that an increase in room temperature adhesion of about 75 percent and of about 158 percent was obtained by the change in the surface of the cured rubber strip from being smooth to being rough to containing the lockable cavity.

It can further be seen from Table 1 that an increase in 95° C. adhesion of about 51 percent and of about 197 percent was obtained by the change in the surface of the cured rubber strip being smooth to being rough to containing the lockable cavity.

These are considered herein to be very significant increases in the representative adhesions.

While certain representative embodiments and details have been shown for the purpose of illustrating the invention, it will be apparent to those skilled in this art that various changes and modifications may be made therein without departing from the spirit or scope of the invention.

1. (canceled)

2. (canceled)

3. (canceled)

4. (canceled)

5. (canceled)

6. A method of preparing a cured rubber tread strip which comprises:
(A) applying a protective removable polymeric film to an uncured rubber tread strip to form a composite thereof, wherein said polymeric film has a melt point, ASTM D789, significantly higher than the cure temperature for said tread rubber strip;
(B) applying a mold release agent to the surfaces of said uncured tread rubber strip composite including at least a portion of the surface of said protective polymeric film on said rubber strip;
(C) applying the release agent coated uncured tread rubber strip composite to a metal plate where said metal plate has:
(1) a plurality of protrusions thereon to form an assembly thereof, or
(2) a roughened surface to form an assembly thereof;
(D) positioning said assembly in a suitable mold and applying an elevated temperature and pressure to:
(1) cause said protrusions of said metal plate to extend into and form lockable cavities in the surface of rubber tread strip, or
(2) cause said roughened surface to impart a roughened surface on the surface of said rubber tread strip;
and to cure said lockable cavity-containing, or roughened surface-containing, rubber tread strip at an elevated temperature to form a rubber tread strip composite comprised of a cured rubber tread strip with a plurality of lockable cavities in its bottom surface, or roughened surface on its bottom surface, and said removable protective polymeric film molded thereon on said cured rubber tread strip including the walls of its lockable cavities or roughened surface.

7. A method of preparing a cured rubber tread strip which comprises:
(A) applying a protective removable polymeric film to an uncured rubber tread strip to form a composite thereof, wherein said polymeric film has a melt point, ASTM D789, significantly higher than the cure temperature for said tread rubber strip, wherein said protective polymeric film has:
(1) a plurality of protrusions thereon, or
(2) an embossed pattern to thereby provide a roughened surface thereon;
(B) applying a mold release agent to the surfaces of said uncured tread rubber strip composite including at least a portion of the surface of said protective polymeric film on said rubber strip;
(C) applying the release agent coated uncured tread rubber strip composite to a flat surfaced metal plate;
(D) positioning said assembly in a suitable mold and applying an elevated temperature and pressure to:
(1) cause said protrusions of said protective polymeric film to extend into and form lockable cavities in the surface of the rubber tread strip, or
(2) cause said roughened surface of said protective polymeric to impart a correspondingly roughened surface to the surface of the rubber tread strip; and to cure said rubber tread strip at an elevated temperature to form a cured rubber tread strip having said removable protective polymeric film molded thereon on said cured rubber tread strip including the walls of its lockable cavities or roughened surface.

8. The method of claim 6 wherein said lockable cavities in said cured tread rubber strip are lockable in a sense of being capable of mechano-chemically interlocking with a rubber cushion layer positioned on a cured rubber tire carcass wherein portions of said rubber cushion layer are caused to protrude into said lockable cavities following which the rubber cushion layer is cured to physically and chemically lock said tread rubber strip to said rubber cushion layer and thereby form a tire assembly comprised of a tire carcass and tread strip with said cushion layer therebetween.

9. The method of claim 6 which further comprises removing said protective polymeric film surface of said cured rubber tread strip, including the walls of said lockable cavities to yield a cured rubber tread strip, and associated walls of said lockable cavities, having a clean unbuffed rubber surface free from mold release agent coating.

10. (canceled)

11. (canceled)

12. The method of claim 6 which further comprises removing said protective polymeric film from the surface of said cured rubber tread strip, including the walls of said lockable cavities to yield a cured rubber tread strip, and associated walls of said lockable cavities, to thereby provide a clean unbuffed rubber surface.

13. The method of claim 7 which further comprises removing said protective polymeric film from the surface of said cured rubber tread strip to thereby provide a clean unbuffed rubber surface.

14. (canceled)

15. (canceled)

16. The method of claim 6 wherein said protective polymeric strip is comprised of at least one of nylon based polymeric film comprised of:
(A) film of open ring polymerized lactams having from 6 to 12 carbon atoms having a melting point in a range of from about 200° C. to about 220° C. (ASTM D789), or
(B) film of a polycondensate of a diamine and dicarboxylic acid as a poly(iminohexamethyleneiminoadipoyl) (polyamide-6,6) having a melting point in a range of from about 250° C. to about 260° C. (ASTM D789).

17. The method of claim 7 wherein said protective polymeric strip is comprised of at least one of nylon based polymeric film comprised of:
(A) film of open ring polymerized lactams having from 6 to 12 carbon atoms having a melting point in a range in a range of from about 200° C. to about 220° C. (ASTM D789), or
(B) film of a polycondensate of a diamine and dicarboxylic acid as a poly(iminohexamethyleneiminoadipoyl) (polyamide-6,6) having a melting point in a range of from about 250° C. to about 260° C. (ASTM D789).
